(19) United States
(12) Patent Application Publication
(10) Pub. No.: US 2008/0032021 A1
(43) Pub. Date: Feb. 7, 2008

(54) Feed supplements for ruminants including essential oil compounds and organic acids

(76) Inventors: Gary L. Faltys, West Point, NE (US); Kelly F. Lechtenberg, Oakland, NE (US)

Correspondence Address: Law Offices of Adam H. Jacobs, Suite 726, 1904 Farnam Street, Omaha, NE, 68102, US

(21) Appl. No.: 11/804,562

(22) Filed: May 18, 2007

Related U.S. Application Data
(60) Provisional application No. 60/801,744, filed on May 19, 2006.

(51) Int. Cl. A23K 1/00; A23L 1/22

(52) U.S. Cl. 426/536

(57) ABSTRACT

A livestock and poultry feed additive composition includes at least one essential oil derived from at least one of an herb and a spice and containing thymol and carvacrol as its main ingredients, at least one organic acid derived from at least one of citric, fumaric, fulvic and humic acid and an organic pharmaceutically acceptable carrier. The total amount of the essential oil in the composition is present in an amount between five percent and forty percent (5% and 40%) by weight of the composition, the total amount of the organic acid in the composition is present in an amount between fifty percent and eighty-five percent (50% and 85%) of the composition by weight and the remainder of the composition consists of the organic pharmaceutically acceptable carrier.

### CROSS-REFERENCE TO RELATED PATENTS

This application claims priority based on a provisional patent, specifically on the Provisional Patent Application Ser. No. 60/801,744 filed May 19, 2006.

### BACKGROUND OF THE INVENTION

1. Technical Field

The present invention relates to a composition which includes essential oil extracts from herbs and spices in combination with organic acids. The essential oil extracts from herbs and spices comprise at least one compound selected from carvacrol, eucalyptol and/or thymol whereby the essential oil extract is present in an amount between five percent to forty percent (5% to 40%) by weight of the composition. The organic acid is derived from citrate, fumarate, L-asparate or L-malate and is present in the composition in an amount between fifty percent to eighty-five percent (50% to 85%) by weight. This composition when fed to ruminants and non-ruminants with a cecum provides for the improvement of growth and/or feed conversion and/or health and well-being and/or fermentation within the rumen and cecum.

2. Description of the Prior Art

The rumen and cecum are non-glandular pouches of the gastro-intestinal tract in such domestic animals as cattle, sheep, goats, horses, poultry and rabbits. Microorganisms including bacteria, protozoa and fungi populate the rumen and cecum and assist the host animal in digesting feedstuffs. Components of feedstuffs including cellulose, hemicellulose, starch, sugars, and proteins are utilized by the microorganisms for their own metabolism or are degraded by the microorganisms into metabolites such as volatile fatty acids (VFA) that are nutrients for the host animal. Simple and complex carbohydrates (fiber) are digested by rumen and cecal microorganisms and converted into VFA. The VFA consist of mainly acetic, propionic and butyric acids and are the primary energy source for ruminants.

Improving the efficiency of feedstuffs utilization and growth of animals has centered on altering the number and/or metabolism of microorganisms with the addition of pharmaceutical compositions to feed rations. Many of these prior art compositions have been removed from animal production in certain markets due to human health concerns. There is therefore a need for a composition which improves feedstuffs utilization and/or growth of animals through means that do not pose a concern to human health.

An ideal feed additive would stimulate endogenous microorganisms to produce metabolites that could in turn be utilized for growth by the animal. Furthermore, the feed additive should be palatable, non-pharmaceutical and significantly enhance the growth and feed conversion of animals compared to those not receiving the feed additive.

Therefore, an object of the present invention is to provide an improved feed additive composition for livestock and poultry.

Another object of the present invention is to provide an improved feed additive composition for livestock and poultry which includes at least one essential oil derived from at least one of an herb and a spice and containing thymol and carvacrol as its main ingredients, at least one organic acid derived from at least one of citric, fumaric, fulvic and humic acid and an organic pharmaceutically acceptable carrier.

Another object of the present invention is to provide an improved feed additive composition for livestock and poultry in which the total amount of essential oil in the composition is between five percent and forty percent (5% to 40%) by weight of the composition.

Another object of the present invention is to provide an improved feed additive composition for livestock and poultry in which the total amount of organic acid in the composition is an amount between fifty percent and eighty-five percent (50% and 85%) of the composition by weight.

Another object of the present invention is to provide an improved feed additive composition for livestock and poultry in which the remainder of the composition, after the essential oil and organic acids are added, consists of the organic pharmaceutically acceptable carrier.

Finally, an object of the present invention is to provide an improved feed additive composition for livestock and poultry which is relatively simple to manufacture and which is safe, efficient and effective in use.

### SUMMARY OF THE INVENTION

A livestock and poultry feed additive composition includes at least one essential oil derived from at least one of an herb and a spice and containing thymol and carvacrol as its main ingredients, at least one organic acid derived from at least one of citric, fumaric, fulvic and humic acid and an organic pharmaceutically acceptable carrier. The total amount of the essential oil in the composition is present in an amount between five percent and forty percent (5% and 40%) by weight of the composition, the total amount of the organic acid in the composition is present in an amount between fifty percent and eighty-five percent (50% and 85%) of the composition by weight and the remainder of the composition consists of the organic pharmaceutically acceptable carrier.

The present invention thus provides an improved livestock and poultry feed additive composition which is superior in many respects to those feed additives currently found in the prior art. For example, the specific restrictions of the ratios of essential oils and organic acids have been found to both enhance the palatability of the feed while simultaneously enhancing the growth of the animal. Furthermore, because the present invention utilizes organic acids of several different kinds, adjustment of the amounts and ratios of the specific organic acids used will allow for tailoring of the supplement to various species of livestock. It is thus seen that the present invention provides a substantial improvement over those supplements found in the prior art.

### DESCRIPTION OF THE PREFERRED EMBODIMENT

The present invention is a feed additive composition which includes at least one essential oil derived from an herb or spice such as anise, capsicum, cinnamon, cloves, eucalyptus, garlic, lemon, oregano, peppermint, rosemary or thyme and an organic acid derived from citrate, fumarate, L-aspartate or L-malate. The composition also preferably includes a carrier such as anhydrous dextrose, calcium carbonate, inert clay, maltodextran, organic product, potassium chloride, propylene glycol, and/or salt. Each of these elements are mixed together in various ratios depending on the intended use of the feed additive composition.

An important feature of the present invention is that the essential oil be present in the composition in an amount between five percent and forty percent (5% to 40%) by weight, and the organic acid be present in the composition in an amount between fifty percent and eighty-five percent (50% to 85%) by weight, with the remainder of the composition consisting of the carrier.

It should be noted that the essential oils and organic acids listed above are representative of the preferred types of herbs, spices and acids to be used in the feed additive, but the composition may be composed of other types of essential oils and organic acids so long as the essential oils and organic acids promote growth and/or improve feed conversion of the animals consuming the feed additive.

It has been discovered that compounds of essential oils including carvacrol (2-methyl-5-isopropylphenol), eucalyptol (1,8-cineole, 1,8-epoxy-P-menthane) and thymol (5-methyl-2-isoprophyl phenol) in combination with organic acids increase growth rate and/or improve feed conversion of animals consuming the composition. Methods by which carvacrol, eucalyptol and thymol are obtained are well-known to the prior art and therefore a further discussion of those methods will not be undertaken in this disclosure. It is preferred that the ratio of carvacrol to thymol range between five to one to nine to one (5 to 1, 9 to 1) in order to provide the best combination for growth promotion. Furthermore, a ratio of eucalyptol to carvacrol of one to one to two to one (1 to 1, 2 to 1) is preferred to provide the best combination for growth promotion.

Further, it has been discovered that a combination of carvacrol, eucalyptol and thymol, in ratios listed above, will increase the concentration of metabolites (VFA) in media containing microorganisms derived from the rumen. Concentrations of VFA are further increased if organic acids are added to media containing the combination of carvacrol, eucalyptol, thymol and microorganisms derived from the rumen. Implications of this discovery are that a composition containing carvacrol, eucalyptol, thymol and organic acids could stimulate the production of VFA in the rumen and cecum and that the increased VFA production could be a mechanism for the enhanced growth observed in animals receiving the composition.

Carvacrol and thymol are found in plants of the Labratae family including oregano, thyme and savory. These compounds are regarded as GRAS (generally recognized as safe) by FEMA and are commonly used as flavoring agents in the human food industry. Eucalyptol is widely distributed in such herbs and spices as eucalyptus, rosemary, sweet basil, and sage. Eucalyptol has been regarded as GRAS by FEMA and is approved by the US Food and Drug Administration for food use.

These compounds are also considered to have antimicrobial, anti-inflammatory and antifungal properties. Discussions about the prophylactic application of these compounds are found in prior art and will not be part of this disclosure. In addition, carvacrol and thymol act as an antioxidant and thus prevent fats from becoming rancid.

Citric, fumaric and malic acids are commonly found in nature and are an intermediate of the tricarboxylic acid cycle (Kreb's cycle). The Kreb's cycle is a pathway for degradation of carbohydrates and generation of energy in humans and animals. These organic acids are also associated with growth of prominent ruminal bacteria.

Aspartic acid is a nonessential amino acid and can be manufactured from other amino acids in the liver. Aspartate is required for growth of microorganism in the rumen and cecum. Aspartic acid is also very important in the urea cycle for the proper elimination of waste products from dietary protein.

### EXAMPLES 1 AND 2

Examples 1 and 2 concern the preparation of a feed additive composition of the present invention in powder, and a water-soluble form, to be added to animal feed and/or drinking water.

### Example 1

| | | |
|---|---|---|
| Ingredient | Young Animal | Adult Animal |

| | | |
|---|---|---|
| Carrier | 30 | 10.5% |
| Organic Acids | 50 | 82% |
| Essential Oils | 20% | 7.5% |

The preparation is blended in a ribbon mixer where the carrier is initially added to the mixer. Organic acids and essential oils are added to the carrier and the mixture is blended for 5 to 7 minutes. The resulting powder is packaged in 25 kg resealable plastic pails. The powder is added to complete feeds for animals and poultry.

### Example 2

| Ingredient | Percentage |
|---|---|
| Citric Acid | 55.00% |
| Anhydrous Dextrose | 15.00% |
| Maltodextran | 5.00% |
| Essential Oils | 25.00% |

The water soluble powder is prepared in a ribbon mixer in an environmentally controlled room. The mixer is charged with citric acid, anhydrous dextrose and maltodextran. The essential oils are added to the above ingredients and blended 5 to 7 minutes. the resulting water soluble powder is packaged in 10 kg or 25 kg resealable plastic pails. The water soluble powder may be added to complete feeds of animals and poultry or to drinking water of animals and poultry via a proportioner.

It is understood that numerous additions, substitutions, and modifications may be made to the feed additive composition of the present invention which fall within the intended broad scope of the above description. For example, the composition, although intended for use with animals (and poultry) that have a rumen or cecum, may be used with virtually any animal of this type in which increased growth and improved feed conversion is desired. Furthermore, although the essential oil has been described as being derived from various types of herbs and spices, the essential oil may be derived from virtually any type of appropriate plant, so long as at least one of the compounds of carvacrol, eucalyptol and thymol are included in the feed additive composition of the present invention.

Furthermore, the organic acid may be derived from other types of acids known in the prior art, so long as the organic acid which is included in the feed additive composition serves to promote the growth component of the feed additive composition. Likewise, the carrier used in connection with the present invention may be drawn from various types of inorganic and organic carriers used in feed additive compositions, so long as it is generally inert and provides an appropriate carrier and/or binder for the feed additive composition. Finally, it should be noted that the ratios of elements in the present invention may be modified or changed so long as they stay within the defined limits of the essential oil in an amount between five percent to forty percent by weight, the organic acid in a concentration of fifty percent to eighty-five percent by weight, and the carrier comprising the remainder of the feed additive composition.

There has therefore been shown and described a feed additive composition for enhancing animal growth, improving feed conversion and/or improving fermentation within the rumen and cecum.

We claim:

1. A livestock and poultry feed additive composition comprising:
at least one essential oil derived from at least one of an herb and a spice and containing thymol and carvacrol as its main ingredients;
at least one organic acid derived from at least one of citric, fumaric, fulvic and humic acid;
an organic pharmaceutically acceptable carrier wherein;
the total amount of said essential oil in said composition being present in an amount between five percent and forty percent (5% and 40%) by weight of said composition;
the total amount of said organic acid in said composition being present in an amount between fifty percent and eighty-five percent (50% and 85%) of said composition by weight; and
the remainder of said composition consisting of said organic pharmaceutically acceptable carrier.

2. The livestock and poultry feed additive composition of claim 1 wherein said at least one essential oil is derived from an herb or spice selected from the group consisting of anise, cinnamon, cloves, eucalyptus, garlic, lemon, oregano, peppermint, rosemary and thyme.

3. The livestock and poultry feed additive composition of claim 1 wherein said at least one organic acid is derived from and acid selected from the group consisting of citric, fumaric, fulvic and humic acid.

4. The livestock and poultry feed additive composition of claim 1 wherein said organic pharmaceutically acceptable carrier is selected from the group consisting of anhydrous dextrose, maltodextran, potassium chloride, salt, calcium carbonate, inert clay and propylene glycol.

5. A livestock and poultry feed additive composition comprising:
at least one essential oil derived from at least one of an herb and a spice selected from the group consisting of anise, cinnamon, cloves, eucalyptus, garlic, lemon, oregano, peppermint, rosemary and thyme and containing thymol and carvacrol as its main ingredients;
at least one organic acid derived from at least one of citric, fumaric, fulvic and humic acid;
an organic pharmaceutically acceptable carrier selected from the group consisting of anhydrous dextrose, maltodextran, potassium chloride, salt, calcium carbonate, inert clay and propylene glycol, wherein;
the total amount of said essential oil in said composition being present in an amount between five percent and forty percent (5% and 40%) by weight of said composition;
the total amount of said organic acid in said composition being present in an amount between fifty percent and eighty-five percent (50% and 85%) of said composition by weight; and
the remainder of said composition consisting of said organic pharmaceutically acceptable carrier.
